(19) United States
(12) Patent Application Publication
(10) Pub. No.: US 2011/0073809 A1
(43) Pub. Date: Mar. 31, 2011

(54) Reduction Of CO2 Emissions From A Steam Methane Reformer And/Or Autothermal Reformer Using H2 As A Fuel

(75) Inventor: Jason W. Faulkner, Collegeville, PA (US)

(73) Assignee: Air Liquide Process and Construction Inc., Houston, TX (US)

(21) Appl. No.: 12/566,715

(22) Filed: Sep. 25, 2009

(51) Int. Cl. C01B 3/32

(52) U.S. Cl. 252/373

(57) ABSTRACT

A process for reducing carbon dioxide emissions from a reforming process is provided. This method includes producing a hot crude syngas stream in a reformer; indirectly exchanging heat between the hot crude syngas stream and a process stream, thereby generating a cool crude syngas stream; and introducing the cool crude syngas stream into a first separation means, thereby producing a syngas stream and a fuel hydrogen stream. The present invention also includes introducing the syngas stream into a second separation means, thereby producing a product syngas stream, and a carbon dioxide rich stream; blending the fuel hydrogen stream with a hydrocarbon stream, thereby producing a blended fuel stream; and introducing the blended fuel stream into a reformer, thereby generating an exhaust stream that has a lower percentage of carbon dioxide than it would without the introduction of the fuel hydrogen stream.

### BACKGROUND

Steam methane reformers (SMR) and autothermal reformers (ATR) emit CO₂ when used for producing hydrogen or syngas. Part of the CO₂ emitted is due to hydrocarbons used as fuel for the steam methane reformer. CO₂ emissions are being regulated and/or taxed in some areas of the world. The regulations/taxes will increase the cost of hydrogen and/or syngas, or the regulations may forbid building new SMRs for hydrogen or syngas production. It is possible to capture the CO₂ from the flue gas, but this is difficult and expensive. For existing plants, physical constraints may make adding the process for capture impossible.

### SUMMARY

The present invention is a method for reducing carbon dioxide emissions from a reforming process. This method includes producing a hot crude syngas stream in a reformer; indirectly exchanging heat between said hot crude syngas stream and a process stream, thereby generating a cool crude syngas stream; and introducing said cool crude syngas stream into a first separation means, thereby producing a syngas stream and a fuel hydrogen stream. The present invention also includes introducing said syngas stream into a second separation means, thereby producing a product syngas stream, and a carbon dioxide rich stream; blending said fuel hydrogen stream with a hydrocarbon stream, thereby producing a blended fuel stream; and introducing said blended fuel stream into a reformer, thereby generating an exhaust stream that has a lower percentage of carbon dioxide than it would without the introduction of said fuel hydrogen stream.

### BRIEF DESCRIPTION OF THE FIGURES

FIG. 1 is a schematic representation of one embodiment of the present invention.

### DESCRIPTION OF PREFERRED EMBODIMENTS

The present invention would use a portion of the product H2 as the fuel or part of the fuel to reduce CO₂ emissions from an SMR or ATR. When H2 is burned it produces no CO2. Capturing CO2 from the process side (the area where H2 or syngas is formed) of an SMR or ATR is cheaper and easier than capturing CO2 in the flue gas. Further, since capture on the process side is already required for CO2 emission reduction, using part of the produced H2 would not greatly increase the cost of equipment or complexity of the plant.

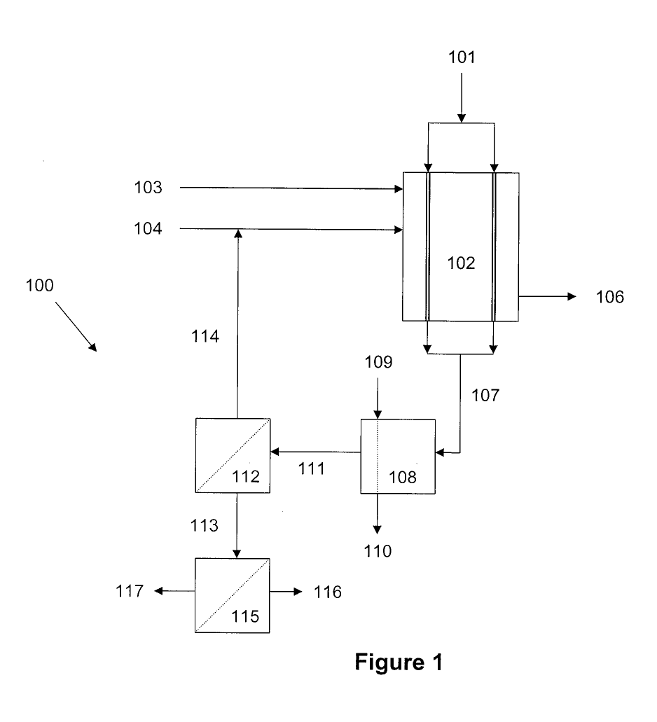

Turning now to FIG. 1, system 100 is presented. Reformer feed stream 101 is introduced into the catalyst tubes of reformer unit 102. Hydrocarbon stream 104 is blended with fuel hydrogen stream 114, thereby producing blended fuel stream 105. Reformer unit 102 may be a Steam Methane Reformer (SMR) or an Autothermal Reformer (ATR). Blended fuel stream 105 is introduced, with combustion oxidant stream 103, into the shell side of reformer 102, where they are combusted thereby providing the temperature and heat required for the reforming process. The products of this combustion exits the shell side of reformer 102 as exhaust stream 106.

Reformer feed stream 101 is converted into hot crude syngas stream 107, which exits reformer 102 and is introduced into process cooling section 108. Within the process cooling section 108, hot crude syngas stream 107 indirectly exchanges heat with cold boiler feed water stream 109, thereby producing heated stream 110, and with the syngas stream exiting as cool crude syngas stream 111. Cool crude syngas stream 111 is then introduced into first separation means 112, where it is separated into syngas stream 113, and fuel hydrogen stream 114. First separation means 112 may be a pressure swing adsorber, a membrane-type separator, or a cryogenic-type separator. Syngas stream is then introduced into second separation means 115, where it is separated into product syngas stream 116, and carbon dioxide rich stream 117. Second separation means 115 may be a pressure swing adsorber, a membrane-type separator, or a cryogenic-type separator. If reformer 102 is an ATR, carbon dioxide rich stream 117 may be blended with fuel gas, and optionally steam, to produce reformer feed stream 101.

What is claimed is:

1. A method for reducing carbon dioxide emissions from a reforming process, comprising;
producing a hot crude syngas stream in a reformer;
indirectly exchanging heat between said hot crude syngas stream and a process stream, thereby generating a cool crude syngas stream;
introducing said cool crude syngas stream into a first separation means, thereby producing a syngas stream and a fuel hydrogen stream,
introducing said syngas stream into a second separation means, thereby producing a product syngas stream, and a carbon dioxide rich stream;
blending said fuel hydrogen stream with a hydrocarbon stream, thereby producing a blended fuel stream; and
introducing said blended fuel stream into a reformer, thereby generating an exhaust stream that has a lower percentage of carbon dioxide than it would without the introduction of said fuel hydrogen stream.

2. The method of claim 1, wherein said first separation means is selected from the group consisting of a pressure swing adsorber, a membrane-type separator, and a cryogenic-type separator.

3. The method of claim 1, wherein said second separation means is selected from the group consisting of a pressure swing adsorber, a membrane-type separator, and a cryogenic-type separator.
